(19) United States
(12) Patent Application Publication
(10) Pub. No.: US 2007/0074137 A1
(43) Pub. Date: Mar. 29, 2007

(54) Database and method of verifying function of LSI using the same

(76) Inventors: Yoshihito Nishida, Osaka (JP); Kazuyoshi Takemura, Osaka (JP); Masanobu Mizuno, Osaka (JP); Kazuhito Tada, Kyoto (JP)

Correspondence Address: MCDERMOTT WILL & EMERY LLP, 600 13TH STREET, N.W., WASHINGTON, DC, 20005-3096, US

(21) Appl. No.: 11/527,406

(22) Filed: Sep. 27, 2006

(30) Foreign Application Priority Data
Sep. 29, 2005 (JP) 2005-285260

(51) Int. Cl. G06F 17/50

(52) U.S. Cl. 716/5

(57) ABSTRACT

Provided is a method of verifying the function of the LSI including: a first signal database generating step of registering a first signal data set for associating a first verification target signal of which the operation is defined as the specification of the LSI with a first depended signal group for influencing the operation of the first verification target signal; a second signal database generating step of registering a second signal data set for associating a second verification target signal which is described in a description language for verifying the function of the LSI and is a verification target with a second depended signal group for influencing the operation of the second verification target signal; and a signal database comparing step of comparing the first signal data set with the second signal data set and outputs a difference. By this method, it is possible to clearly associate each signal of a specification and an assertion description of the LSI or a HDL with a signal group for influencing the operation of the signal and to find a possibility that the verified item or the assertion description is omitted or a signal operation which was not included in the HDL or the defect of the specification document by comparing signal data sets registered in signal databases with each other.

### BACKGROUND OF THE INVENTION

1. Field of the Invention

The present invention relates to a database and a method of verifying a function of a large-scale integrated circuit (LSI) using the same, and more particularly, to a method of efficiently verifying a function of a LSI.

2. Description of the Related Art

Recently, as large scale or high integration of a LSI is progressing and a circuit arrangement becomes complicated, the number of items to be verified by verification of a function of the LSI is increasing exponentially and bug of the LSI due to omission of the function verification or misunderstanding of verified contents is also increasing. As a LSI function verifying device for solving such problems, a formal function verifying device which need not prepare a test pattern in addition to a function simulator is used.

In a conventional LSI function verifying method, since the formal function verifying device is basically similar to the function simulator, a person understands a specification document of a LSI to extract verified items, directly describes the items in an input format of each function verifying device, and verifies the function using the function verifying device. In general, the specification document of the LSI mainly describes functional operations, and, when the function simulator is used, a test pattern according to the order of the functional operations or a test bench for generating the test pattern is prepared. When the formal function verifying device is used, a function verification description language, which expresses a portion of a series of functional operations described in the specification document or restriction, is prepared.

In a conventional LSI function verifying method, when items to be verified are extracted from a specification document, since the specification document mainly describes the functional operations, the verified items to be extracted depends on a sentence of the specification document or a person who reads the sentence. Accordingly, omission or misunderstanding of the specification is caused and thus the verified items cannot be sufficiently verified or erroneous. As the result, the verification of the function of the LSI may be omitted and a problem of the LSI may not be found.

### SUMMARY OF THE INVENTION

The present invention is to solve the conventional problems, and it is an object of the present invention to easily verify a function of a LSI.

It is another object of the present invention to reduce omission of function verification of a LSI.

It is another object of the present invention to provide a LSI function verifying method capable of shortening a function verifying period.

In order to accomplish the above-described objects, according to the present invention, there is provided a method of verifying a function of a LSI including: a first signal database generating step of registering a first signal data set for associating a first verification target signal of which the operation is defined as the specification of the LSI with a first depended signal group for influencing the operation of the first verification target signal; a second signal database generating step of registering a second signal data set for associating a second verification target signal which is described in a description language (hereinafter, referred to as assertion description) for verifying the function of the LSI and is a verification target with a second depended signal group for influencing the operation of the second verification target signal; and a signal database comparing step of comparing the first signal data set with the second signal data set and outputs a difference.

Similarly, the function of the LSI can be verified by replacing the assertion description of the LSI with a description language (hardware description language; hereinafter referred to as HDL) for expressing the function of the LSI.

That is, in the present invention, the database used for verifying the function of the LSI stores a signal data set which associates a verification target signal of the LSI having a defined operation with a depended-signal group which influences the operation of the verification target signal is stored in a design specification or a description generated based on the design specification. By this configuration, it is possible to clearly associate each signal with a signal group for influencing the operation of the signal.

In the present invention, the data set includes a first signal data set which associates a first verification target signal having a defined operation as the specification of the LSI with a first depended signal group which influences the operation of the first verification target signal, and a second signal data set which associates a second verification target signal which is a verification target in a description language for verifying the function of the LSI with a second depended signal group which influences the operation of the second verification target signal.

By this configuration, it is possible to clearly associate each signal with a signal group for influencing the operation of the signal and to easily compare and verify different descriptions.

In the present invention, the data set includes a first signal data set which associates a first verification target signal which is a verification target in a first description language for verifying the function of the LSI with a first depended signal group which influences the operation of the first verification target signal, and a second signal data set which associates a second verification target signal which is a verification target in a second description language for verifying the function of the LSI with a second depended signal group which influences the operation of the second verification target signal.

By this configuration, it is possible to clearly associate each signal with a signal group for influencing the operation of the signal and to easily compare and verify a specification document and a description language.

According to the present invention, there is a method of verifying a function of a LSI, including: a signal database generating step of generating a plurality of signal data sets for associating a verification target signal of the LSI having a defined operation with a depended signal group for influencing the operation of the verification target signal, with respect to design specifications or descriptions having a plurality of different description rules generated based on the design specifications; and a signal database comparing step of comparing at least two of the signal data sets with each other and outputs a difference.

By this configuration, it is possible to clearly associate each signal with a signal group for influencing the operation of the signal and to easily compare and verify the design specifications or descriptions based on the design specifications.

In the present invention, in the method of verifying the function of the LSI, the signal data sets are generated with respect to description levels having different abstract degrees, respectively.

By this configuration, it is possible to clearly associate each signal with a signal group for influencing the operation of the signal and to easily compare and verify descriptions based on the description levels having the different abstract degrees.

In the present invention, the method of verifying the function of the LSI includes: a first signal database generating step of registering a first signal data set for associating a first verification target signal of which the operation is defined as the specification of the LSI with a first depended signal group for influencing the operation of the first verification target signal; a second signal database generating step of registering a second signal data set for associating a second verification target signal which is described in a description language for verifying the function of the LSI and is a verification target with a second depended signal group for influencing the operation of the second verification target signal; and a signal database comparing step of comparing the first signal data set with the second signal data set and outputs a difference.

By this configuration, it is possible to efficiently and accurately perform verification by comparison between the specification and the function description.

In the present invention, the method of verifying the function of the LSI includes: a first signal database generating step of registering a first signal data set for associating a first verification target signal of which the operation is defined as the specification of the LSI with a first depended signal group for influencing the operation of the first verification target signal; a second signal database generating step of registering a second signal data set for associating a second verification target signal which is described in a hardware description language (hardware description language; hereinafter, referred to as HDL) for expressing the function of the LSI and is a verification target with a second depended signal group for influencing the operation of the second verification target signal; and a signal database comparing step of comparing the first signal data set with the second signal data set and outputs a difference.

By this configuration, it is possible to efficiently and accurately perform verification by comparison between different descriptions.

In the present invention, the method of verifying the function of the LSI includes: a first signal database generating step of registering a first signal data set for associating a first verification target signal of which the operation is defined as the specification of the LSI with a first depended signal group for influencing the operation of the first verification target signal; a second signal database generating step of registering a second signal data set for associating a second verification target signal of a HDL for expressing the function of the LSI with a second depended signal group for influencing the operation of the second verification target signal; and a signal database comparing step of comparing the first signal data set with the second signal data set and outputs a difference.

By this configuration, it is possible to efficiently and accurately perform verification by comparison between a specification and a HDL description.

In the present invention, the method of verifying the function of the LSI includes: a first signal database generating step of registering a first signal data set for associating a first verification target signal of a first HDL with a first depended signal group for influencing the operation of the first verification target signal; a second signal database generating step of registering a second signal data set for associating a second verification target signal of a second HDL which is different from the first HDL in a time related to transmission/reception of data between signals with a second depended signal group for influencing the operation of the second verification target signal; and a signal database comparing step of comparing the first signal data set with the second signal data set and outputs a difference.

By this configuration, it is possible to efficiently and accurately perform verification by comparison between HDL descriptions having different concepts.

In the present invention, the method of verifying the function of the LSI includes: a step of adding information on delay time required until the first depended signal of the first signal data set influences the first verification target signal of the first signal data set to the first signal data set registered in the first signal database generating step in association with the first depended signal; and a step of adding information a delay time required until the second depended signal of the second signal data set influences the second verification target signal of the second signal data set to the second signal data set registered in the second signal database generating step in association with the second depended signal.

By this configuration, it is possible to perform comparison in a time axis by registering the delay time required for changing the input signal and then reaching the signal in the database.

In the present invention, in the method of verifying the function of the LSI, the information on the delay time is expressed by a clock signal and the number of clock cycles.

By this configuration, it is possible to more easily perform comparison in a time axis by registering the delay time required for changing the input signal and then reaching the signal in the database.

In the present invention, the method of verifying the function of the LSI including: a first or second signal database generating step of registering a signal data set for associating only a depended signal group which directly influences a verification target signal with the verification target signal.

By this configuration, since the signal data set for associating only the depended signal group for directly influencing the verification target signal with the verification target signal is registered, it is possible to reduce the size of data. In addition, when the delay time information is included, it is possible to output the delay time information of various paths by accumulating nodes. In addition, when a plurality of signal paths exists, it is possible to efficiently find mismatching among the delay times of the paths.

In the present invention, the method of verifying the function of the LSI including: a clock signal table generating step of extracting a verification target signal and a depended signal of the verification target signal, which are synchronized with an identical clock signal, and generates a table list of signals which operate in synchronization with the clock signal, the depended signal directly influencing the verification target signal; and a step of automatically setting the information on the delay time in which the clock signal and the number of the clock cycles are 1, from the clock signal table generated in the clock signal table generating step and the signal database generated in the signal database generating step.

By this configuration, it is possible to simplify the delay time of each node to one clock cycle by layering registers as a cycle base and to omit a process for inputting the delay time information.

In the present invention, the method of verifying the function of the LSI includes: a global signal extracting step of extracting depended signals which influence the operations of at least a specified number of verification target signals, with respect to the database generated in the signal database generating step; and a global signal specification table output step of outputting a table which can describe the operations of the verification target signals which are influenced by a global signal, with respect to the value of the global signal extracted in the global signal extracting step or a value changing direction. By this configuration, it is possible to improve the quality level of the specification document by finding the global signal and outputting a specification-format template of the global signal.

In the present invention, the method of verifying the function of the LSI includes: a global signal table output step of outputting a table which can describe the operation of the verification target signal by collecting the verification target signals of which the operations are influenced by the global signal to each functional block and describing each operation in each functional block with respect to the functional block in which the operations of the verification target signals belonging to the identical functional block are identical, with respect to the value of the global signal extracted in the global signal extracting step or a value changing direction.

By this configuration, it is possible to omit an input process and to simplify the operation when the operations of the verification target signals in an identical functional block are identical.

In the present invention, the method of verifying the- function of the LSI includes: a step of giving a mode attribute to the global signal with respect to a functional block in which the value of the verification target signal, of which the operation is influenced by the global signal, is uniquely determined by the value of the global signal; and a global signal specification output step of outputting a table which sets the value of the verification target signal, of which the operation is influenced by the global signal, with respect to the value of the global signal. By this configuration, it is possible to omit a process of generating the specification by outputting a specification-format template suitable for the global signal.

In the present invention, the method of verifying the function of the LSI includes: a verification description language output step of outputting a description language for verifying the function based on input information on the table output in the global signal specification table output step.

By this configuration, it is possible to output the assertion by outputting a description-format template suitable for the global signal.

In the present invention, the method of verifying the function of the LSI includes: a step of giving an initial sequence attribute, in which the value of the global signal and the value of the verification target signal of which the operation is influenced by the global signal within a predetermined period from a global signal changing time are uniquely determined, to the global signal; and a global signal specification output step of outputting a table which sets the value of the verification target signal, of which the operation is influenced by the global signal, with respect to the value of the global signal and the predetermined period from the global signal changing time.

By this configuration, it is possible to simplify data.

In the present invention, the method of verifying the function of the LSI includes: a verification description language output step of outputting a description language for verifying the function based on input information on the table output in the global signal specification table output step.

In the present invention, the method of verifying the function of the LSI includes: a step of registering a port of a first functional block as a first verification target signal and registering a port group of a second functional block which is connected with the first verification target signal as a depended signal group of the first verification target signal, in a specification signal database; a global signal extracting step of extracting a first depended signal which influences the operations of at least two verification target signal groups; an identical operation connection verification description language output step of outputting a description language for verifying the function, which represents that the operations of a second verification target signal in a signal data set registered in the specification signal database and a second depended signal associated with the second verification target signal are always identical; a complex operation connection signal specification table output step of outputting a table for associating a depended signal group including a global signal of a third verification target signal of which the operation is influenced by the global signal extracted in the global signal extracting step with the third verification target signal; a connection logic operation input step of inputting a logic operation due to a depended signal group of a fourth verification target signal which determines the value of the fourth verification target signal expressed in the complex operation connection signal specification table to the complex operation connection signal specification table output in a complex operation connection signal specification table output step; and a complex operation connection verification description language output step of outputting a description language for verifying the function based on the input information of the connection logic operation input step.

In the present invention, the method of verifying the function of the LSI includes: a signal database generating step of registering a signal data set for associating a verification target signal of a HDL with a depended signal group which influences the operation of the verification target signal, with respect to the HDL of the LSI; a simulating step of simulating the HDL by inputting signal database generated in the signal database generating step; a signal coverage recording step of recording a change in the value of the depended signal group in the signal data set in association with the depended signal; and a coverage output step of outputting how many combinations of the change of the value of the depended signal group is recorded, with respect to the combination of the value of the depended signal group in a signal coverage recording step.

By this configuration, it is possible to efficiently calculate the coverage.

In the present invention, the method of verifying the function of the LSI includes: a depended signal value combination extracting step of adding the combination of the value of the depended signal group of the signal data set to the signal data set in association with the depended signal group; a depended signal value combination recording step of adding the number of the changes in each combination to the signal data set in association with the combination whenever the combination of the value of the depended signal group in the simulating step is changed; and a coverage record transferring step of transferring a record result to a second signal data set in which a first verification target signal of a first signal data set is a depended signal, with respect to the combination of the signal value of a first depended signal group of the first signal data set recorded in the signal coverage recording step.

In the present invention, the method of verifying the function of the LSI includes: a step of, when a signal name of a description language for verifying the function of the LSI does not exist in a specification of the LSI, adding information for associating the signal name with the specification to a signal database generated in a third signal database generating step related to the description language for verifying the function and the specification, from the result of a first signal database comparing step related to the specification and the description language for verifying the function and the result of a second signal database comparing step related to the specification and the HDL of the LSI.

In a conventional method, since a verified item is extracted depending on a sentence of a specification or a person who reads the sentence, function verification may be omitted. However, according to the LSI function verifying method of the present invention, it is possible to clearly associate each signal of a specification and an assertion description of the LSI or a HDL with a signal group for influencing the operation of the signal and to find a possibility that the verified item or the assertion description is omitted or a signal operation which was not included in the HDL or the defect of the specification document by comparing signal data sets registered in signal databases with each other.

### BRIEF DESCRIPTION OF THE DRAWINGS

FIG. 1 is a view showing a basic concept of a method according to a first embodiment of the present invention.

FIG. 2 is a view showing the method of the first embodiment of the present invention.

FIG. 3 shows a data set and comparison data which can be obtained in the first embodiment of the present invention.

FIG. 4 is a view showing an example of a data set which can be obtained in the first embodiment of the present invention.

FIG. 5 is a view showing a database according to a second embodiment of the present invention.

FIG. 6 is a view showing a database according to a third embodiment of the present invention.

FIG. 7 is a view showing a database according to a fourth embodiment of the present invention.

FIG. 8 is a view showing a database according to a fifth embodiment of the present invention.

FIG. 9 is a view showing an example of a data set which can be obtained in a sixth embodiment of the present invention.

FIG. 10 is a view showing a method according to a seventh embodiment of the present invention.

FIG. 11 is a view showing a method according to an eighth embodiment of the present invention.

FIG. 12 is a view showing a method according to a ninth embodiment of the present invention.

FIG. 13 is a view showing a method according to a tenth embodiment of the present invention.

FIG. 14 is a view showing a global signal specification in a step of generating a database according to an eleventh embodiment of the present invention.

FIG. 15 is a view showing a global signal specification in a step of generating a database according to a twelfth embodiment of the present invention.

FIG. 16 is a view showing a global signal specification in a step of generating a database according to a thirteenth embodiment of the present invention.

FIG. 17 is a view showing a global signal specification in a step of generating a database according to a fourteenth embodiment of the present invention.

FIG. 18 is a view showing the global signal specification in the step of generating the database according to the fourteenth embodiment of the present invention.

FIG. 19 is a view showing a method according to a fifteenth embodiment of the present invention.

FIG. 20 is a view showing a method according to a seventeenth embodiment of the present invention.

FIG. 21 is a view showing a method according to an eighteenth embodiment of the present invention.

FIG. 22 is a view showing a method according to a nineteenth embodiment of the present invention.

### DESCRIPTION OF THE PREFERRED EMBODIMENTS

(First embodiment)

Hereinafter, a LSI function verifying method according to an embodiment (hereinafter, referred to as a first embodiment) of the present invention will be described with reference to the attached drawings. In the present embodiment, a verified signal related to a verifying signal is extracted from descriptions having different description rules and signal data sets which associate a verification target signal having a defined operation with a depended signal group which influences the operation of the verification target signal are generated, and databases for storing the signal data sets are used.

In the LSI function verifying method according to the present embodiment, by comparing the signal data sets are compared using the databases and determining whether there is a difference to detect omission or error of the description, matching is checked. In addition, it is checked whether the function is properly verified.

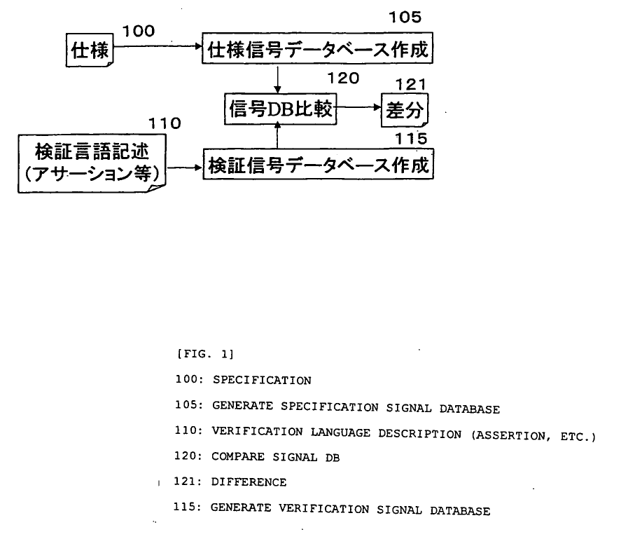

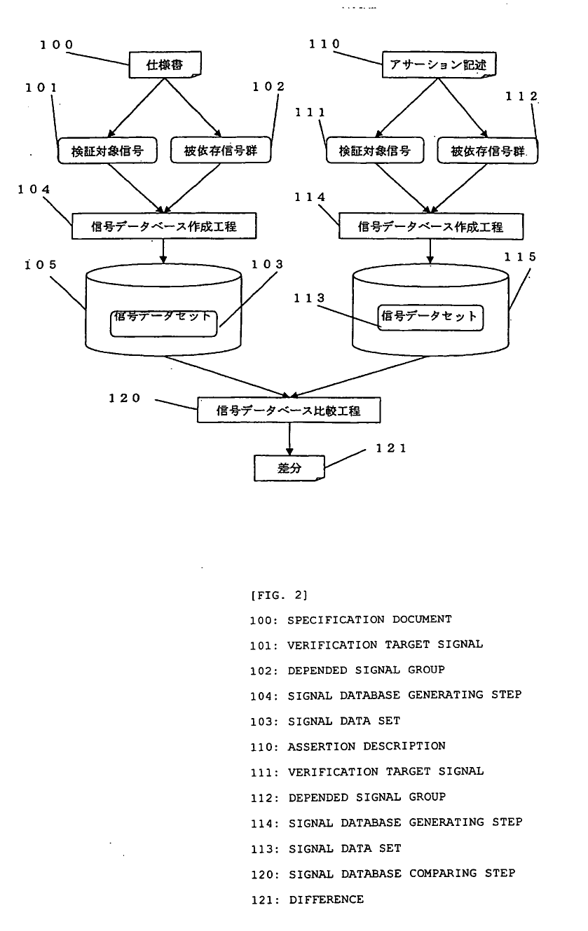

FIG. 1 is a view showing the LSI function verifying method according to the first embodiment of the present invention and FIG. 2 is a view showing respective steps and a configuration of input/output information. As an example of descriptions having different description rules, a specification document of a LSI and an assertion description as a verification language description are compared and verified. As shown in FIG. 1, a verified signal related to a verifying signal is extracted from the specification document 100, and a specification signal database 105 composed of a signal data set which associates a verification target signal having a defined operation with a depended signal group which influences the operation of the verification target signal is generated. A verified signal related to a verifying signal is extracted from an assertion description 110 on the LSI and a verifying signal database 115 composed of a signal data set which associates a verification target signal having a defined operation with a depended signal group which influences the operation of the verification target signal is generated. The specification signal database 105 and the verifying signal database 115 are compared with each other (120) to obtain a difference 121.

The matching/mismatching of each description is determined depending on whether the difference is in a predetermined range.

As shown in FIG. 2 in detail, the verification target signal 101 of which the operation is defined in the specification document 100 and the depended signal group 102 which influences the operation of the verification target signal 101 are extracted from the specification document 100 of the LSI, the signal data set 103 for associating the verification target signal 101 with the depended signal group 102 is generated (104), and the signal database 105 is generated by registering the signal data set 103 (signal database generating step 104).

The verification target signal 111 of which the operation is defined in the assertion description 110 and the depended signal group 112 which influences the operation of the verification target signal 111 are extracted from the specification document 110 of the LSI, the signal data set 113 for associating the verification target signal 111 with the depended signal group 112 is generated (114), and the signal database 105 is generated by registering the signal data set 113 (signal database generating step 114).

The signal data set 103 and the signal data set 113 are extracted from the signal database 105 and the signal database 115, respectively, and are compared with each other in a signal database comparing step 120 to obtain the difference 121. The matching/mismatching of each description is determined depending on whether the difference is in the predetermined range.

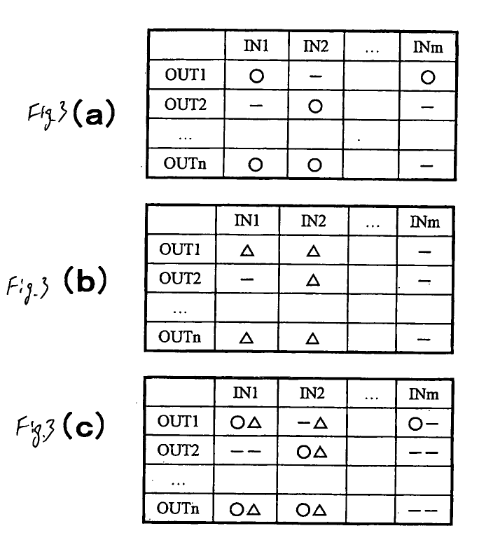

FIG. 3 is a view showing a configuration of the signal data set registered in the signal database generating step of the LSI function verifying method according to the first embodiment of the present invention. In FIG. 3, the verification target signal 101a and the depended signals 102a, 102b and 102c extracted from the specification document 100 of the LSI are associated with each other to configure the specification signal data set 103. Meanwhile, the verification target signal 111a and the depended signals 112a and 112c extracted from the assertion description 110 are associated with each other to configure the assertion signal data set 113. The specification signal data set 103 and the assertion signal data set 113 are compared in the signal database comparing step 120 to output the difference 121.

Now, the operation of the LSI function verifying method having the above-described configuration will be described.

With respect to the verification target signal 101 selected from the specification document 100, the depended signal group 102 which influences the operation of the verification target signal 101 is extracted from the specification document, the verification target signal 101 and the depended signal group are treated as one signal data set 103, the signal data set 103 is registered in the signal database generating step 104, thereby generating the signal database 105.

Similarly, the verification target signal 111 is selected from the assertion description 110, the depended signal group 112 which influences the operation of the verification target signal 111 is extracted from the assertion description, the verification target signal 111 and the depended signal group are treated as one signal data set 113, the signal data set 113 is registered in the signal database generating step 114, thereby generating the signal database 115. The signal data set 103 registered in the signal database 105 and the signal data set 113 registered in the signal database 115 are compared with each other in the signal database comparing step 120 to output the difference 121 representing information on the depended signal which exists in the signal data set 103 but does not exist in the signal data set 113 or the depended signal which exists in the signal data set 113 but does not exist in the signal data set 103, or information on the depended signal which exists in both the signal data set 103 and the signal data set 113.

The result is, for example, shown in FIGS. 3A to 3C as the signal data set. FIGS. 3A and 3B show the signal data set 103 based on the specification document and the signal data set 113 based on the assertion description 110, respectively. FIG. 3C is comparison data showing the difference for synthesizing and comparing the signal data sets. As can be seen from FIG. 3C, it is reported that, for example, in the difference 121, IN1 has an influence on the operation of a signal name OUT1 of the signal data set 103 based on the specification document (ο), but does not have an influence on the operation of a signal name OUT1 of the signal data set 113 based on the assertion description (Δ).

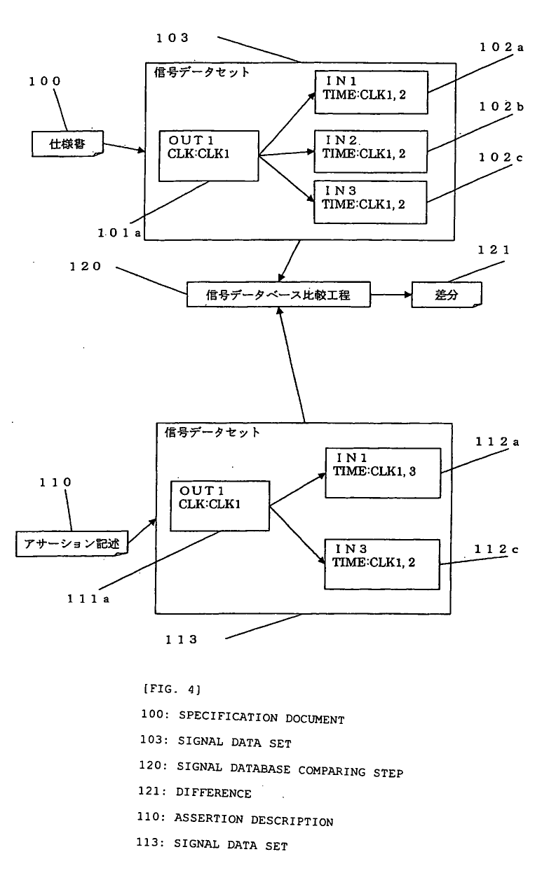

The data set expressed by another method is, for example, shown in FIG. 4. When the verification target signal 101a are associated with the depended signals 102a, 102b and 102c in the signal data set 103 with respect to the specification document 100 and the verification target signal 111a is associated with the depended signals 112a and 112c in the signal data set 113 with respect to the assertion description 110, it is reported that a signal name IN2 of the depended signal 102b is not included in the assertion description on the signal name OUT1 of the verification target signal 111a in the difference 121.

By adding delay times required for changing the depended signals 102a, 102b and 102c and then influencing the verification target signal 101a, the delay times are simultaneously compared. The verification target signal and the depended signal are limited to a signal which operates in synchronization with the clock of a register or a latch. To this end, the delay time added to the depended time can be replaced with the number of clock cycles. For example, in Figure, IN1 TIME: CLK1,2″ means that a delay time (cycle) required for inputting a clock signal CLK1 to IN1 and reaching the output signal name OUT1 is 2. Since CLK1,2 is expressed in the depended signal 102a based on the specification document but CLK1,3 is expressed in the depended signal 112a based on the assertion description, it is reported that delay times are different from each other.

(Second Embodiment)

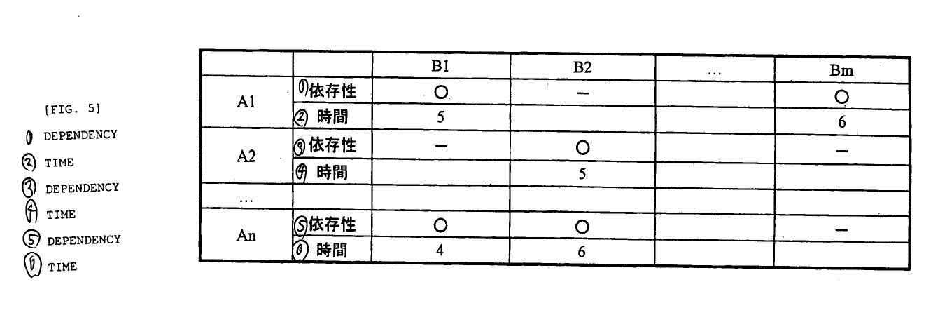

Next, a database having delay time information will be described as a modified example of the database used herein. As shown in FIG. 5, by adding delay times required for changing depended signals B1, B2, . . . , and Bm and then reaching verification target signals A1, A2, . . . , and An, comparison can be performed in a time axis. In Figure, the time uses a predetermined unit time. By storing such a signal data set, the delay times are simultaneously compared. “ο” denotes that the depended signal directly has an influence on the operation of the verification target signal and “−” denotes does not have an influence on the operation of the verification target signal.

(Third Embodiment)

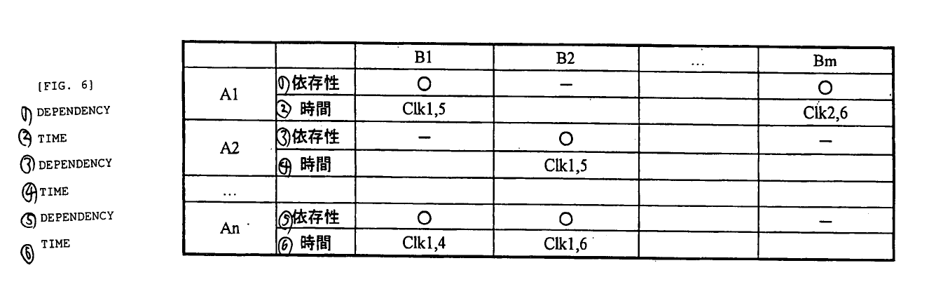

Next, a database having delay time information will be described as another modified example of the database used herein. As shown in FIG. 6, delay times required for changing depended signals B1, B2, . . . , and Bm and then reaching verification target signals A1, A2, . . . , and An are expressed by the number of the clock cycles and comparison is performed in a time axis by adding delay data Clk1,5, Clk1,6,. . . The delay data Clk1,5 denotes that a clock signal Clk1 is delayed by five cycles in the verification target signal and the delay data Clk1,6 denotes that the clock signal Clk1 is delayed by six cycles in the verification target signal. By storing such a signal data set, the delay times are simultaneously compared.

(Fourth Embodiment)

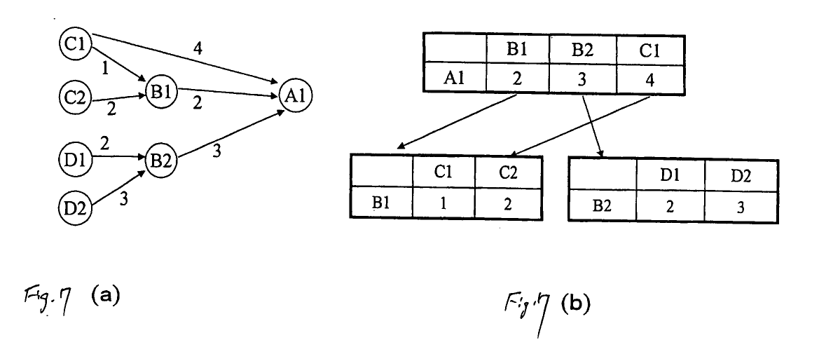

Next, a layered database will be described as another modified example of the database used herein. As shown in FIGS. 7A and 7B, in the layered database, a signal data set which associates only a depended signal group which directly influences the verification target signal with the verification target signal is generated and stored. FIG. 7A is a view showing a structure of the layered database and FIG. 7B is a view showing storage data. For example, depended signals which directly influence the verification target signal A1 are B1, B2 and C1, and C1 and C2 are depended signal which directly influences B1. In addition, depended signals which directly influence the depended signal B2 are D1 and D2. By storing a signal data set obtained by layering A, B and C and adding delay information together with layering information, the delay times are simultaneously compared.

By using the layered database, it is possible to reduce the size of the data. Since the database is generated to include the delay time information, the delay time information on various paths can be output by accumulating nodes. When a plurality of paths exists from any one node to the other node, mismatching such as different delay times among the paths may be found. For example, while the delay information on the depended signal A1 which directly influences the verification target signal C1 is 4, the depended signal B1 which directly influences the verification target signal C1 is 1 and the depended signal A1 which directly influences the depended signal B1 is 2, which amounts to 3. From this result, it can be seen that the delay times among the paths are different from each other and thus the layered database includes a mismatched portion. The mismatching means that an error may be generated, not impossibility.

(Fifth Embodiment)

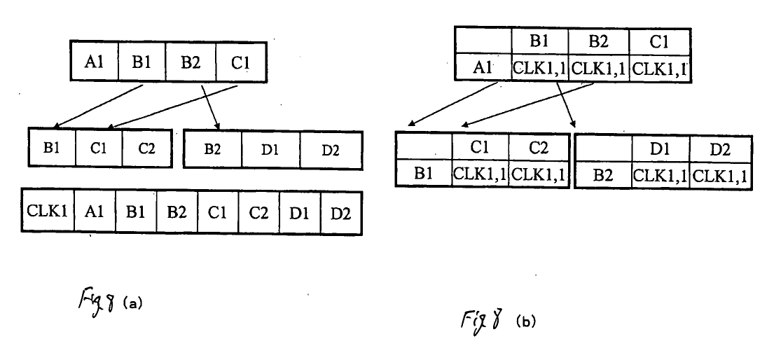

Next, a method of layering registers as a cycle base and simplifying the delay time of each node to one clock cycle will be described as another modified example of the database used herein. In this method, data on the delay time of each node can be simplified and thus a process of acquiring delay time information can be omitted. In the register layering database, as shown in FIGS. 8A and 8B, a signal data set which associates only a depended signal group which directly influences a verification target signal with the verification target signal is generated and stored.

That is, as shown in FIG. 8A, the verification target signal A1 and the depended signals B1, B2, C1, C2, D1 and D2 of the verification target signal are synchronized with a same clock signal, the depended signals which directly influence the verification target signal are extracted, and a table list of a signal which operates in synchronization with the clock signal is generated, as shown in FIG. 8B. A delay time information of which the number of the clock cycles is 1 and the clock signal are automatically set from the clock signal table and the signal database generated in the signal database generating step.

By layering the register as the cycle base, the delay time of each node can be simplified to one clock cycle and thus a process of inputting delay time information can be omitted.

(Sixth Embodiment)

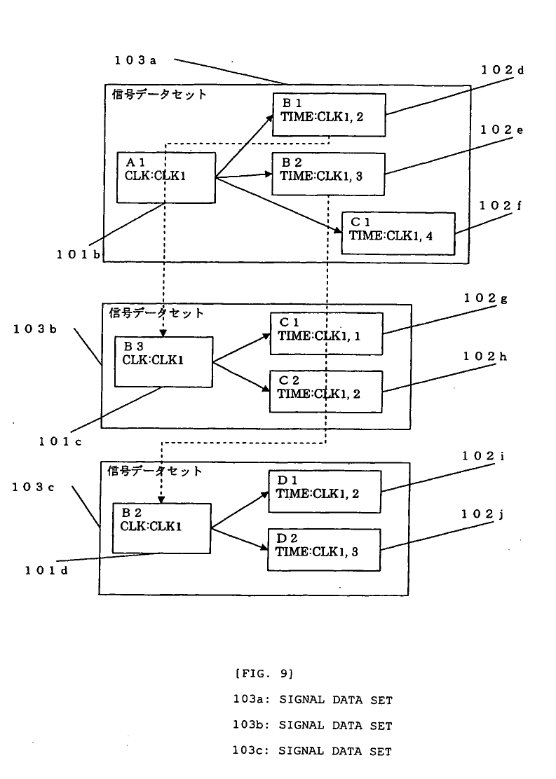

A LSI function verifying method using a register layering database will be described. In this method, verification is performed using the same process as that of the first embodiment described with reference to FIG. 2 and a signal data set configures a register layering structure as shown in FIG. 9. For example, a signal data set which associates only depended signals 102d, 102e and 102f which directly influence a verification target signal 101b with the verification target signal 101b is registered and the depended signal 102d also is used as a verification target signal 101c. A signal data set 103b which associates only depended signals 102g and 102h which directly influence the verification target signal 101c with the verification target signal 101c is registered and the depended signal 102e is also used as a verification target signal 101d. A signal data set 103c which associates only depended signals 102i and 102j which directly influence the verification target signal 101d with the verification target signal 101d is registered.

The verification target signal or the depended signal is limited to a signal which operates in synchronization with the clock of the register or a latch, the size of the signal database can be reduced. In addition, a delay time added to the depended signal is replaced with the number of clock cycles, information on clock domains can be also compared, and thus a larger amount of contents can be verified. By limiting the depended signal associated with the verification target signal and registered as the signal data set in the signal database to a signal which directly influences the verification target signal, the size of the signal database can be reduced and association with the register structure of a HDL is possible.

(Seventh Embodiment)

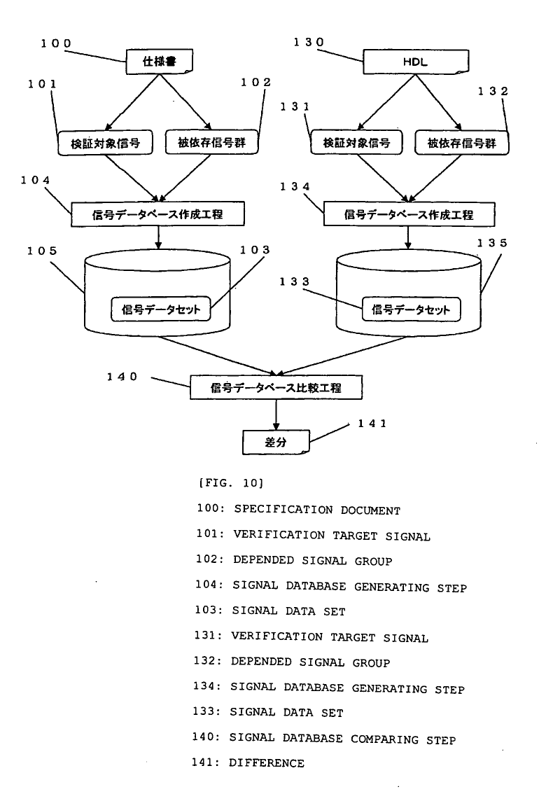

Next, a seventh embodiment of the present invention will be described. In the present embodiment, verification is performed by comparing a specification document of a LSI with a HDL description. FIG. 10 shows a configuration of respective steps and input/output information. As an example of descriptions having different description rules, the verification is performed by comparing the specification document of the LSI with the HDL description. As shown in FIG. 10, a verified signal related to a verifying signal is extracted from the specification document 100, and a specification signal database 105 composed of a signal data set which associates a verification target signal having a defined operation with a depended signal group which influences the operation of the verification target signal is generated. A verified signal related to a verifying signal is extracted from the HDL description 130 on the LSI and a verifying signal database 135 composed of a signal data set which associates a verification target signal having a defined operation with a depended signal group which influences the operation of the verification target signal is generated. The specification signal database 105 and the HDL signal database 135 are compared with each other (140) to obtain a difference 141.

The matching/mismatching of each description is determined depending on whether the difference is in a predetermined range.

That is, a verification target signal 101 of which the operation is defined in the specification document 100 and a depended signal group 102 which influences the operation of the verification target signal 101 are extracted from the specification document 100 of the LSI, a signal data set 103 for associating the verification target signal 101 with the depended signal group 102 is generated (104), and the signal database 105 is generated by registering the signal data set 103 (signal database generating step 104).

A verification target signal 131 of which the operation is defined in the HDL description 130 generated from the specification document 110 of the LSI and a depended signal group 132 which influences the operation of the verification target signal 131 are extracted, a signal data set 133 for associating the verification target signal 131 with the depended signal group 132 is generated (134), and the signal database 135 is generated by registering the signal data set 133 (signal database generating step).

The signal data set 103 and the signal data set 133 are extracted from the signal database 105 and the signal database 135, respectively, and are compared with each other in a signal database comparing step 140 to obtain the difference 141. The matching/mismatching of each description is determined depending on whether the difference is in the predetermined range.

(Eighth Embodiment)

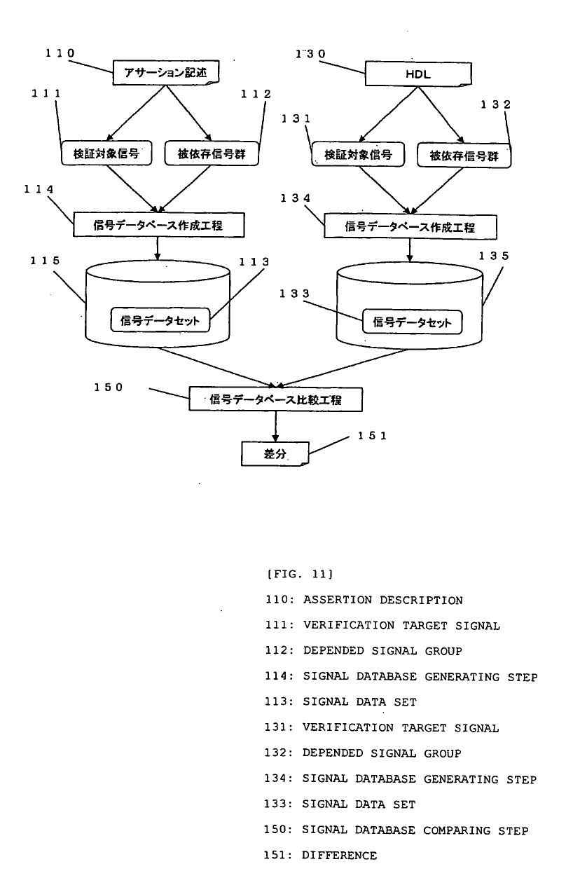

Next, an eighth embodiment of the present invention will be described. In the present embodiment, verification is performed by comparing a specification document of a LSI with a HDL description. FIG. 11 shows a configuration of respective steps and input/output information. As an example of descriptions having different description rules, the verification is performed by comparing the specification document of the LSI with the HDL description. As shown in FIG. 11, a verified signal related to a verifying signal is extracted from an assertion description 110, and an assertion description signal database 105 composed of a signal data set which associates a verification target signal having a defined operation with a depended signal group which influences the operation of the verification target signal is generated. A verified signal related to a verifying signal is extracted from the HDL description 130 on the LSI, and a verifying signal database 135 composed of a signal data set which associates a verification target signal having a defined operation with a depended signal group which influences the operation of the verification target signal is generated. The assertion description signal database 115 and the HDL signal database 135 are compared with each other (150) to obtain a difference 151.

The matching/mismatching of each description is determined depending on whether the difference is in a predetermined range.

That is, a verification target signal 111 of which the operation is defined in the assertion description 110 and a depended signal group 112 which influences the operation of the verification target signal 111 are extracted from the assertion description 110, a signal data set 113 for associating the verification target signal 111 with the depended signal group 112 is generated (114), and the signal database 115 is generated by registering the signal data set 113 (signal database generating step 114).

A verification target signal 131 of which the operation is defined in the HDL description 130 generated from the specification document 110 of the LSI and a depended signal group 132 which influences the operation of the verification target signal 131 are extracted, a signal data set 133 for associating the verification target signal 131 with the depended signal group 132 is generated (134), and the signal database 135 is generated by registering the signal data set 133 (signal database generating step).

The signal data set 113 and the signal data set 133 are extracted from the signal database 115 and the signal database 135, respectively, and are compared with each other in a signal database comparing step 150 to obtain the difference 151. The matching/mismatching of each description is determined depending on whether the difference is in the predetermined range.

(Ninth Embodiment)

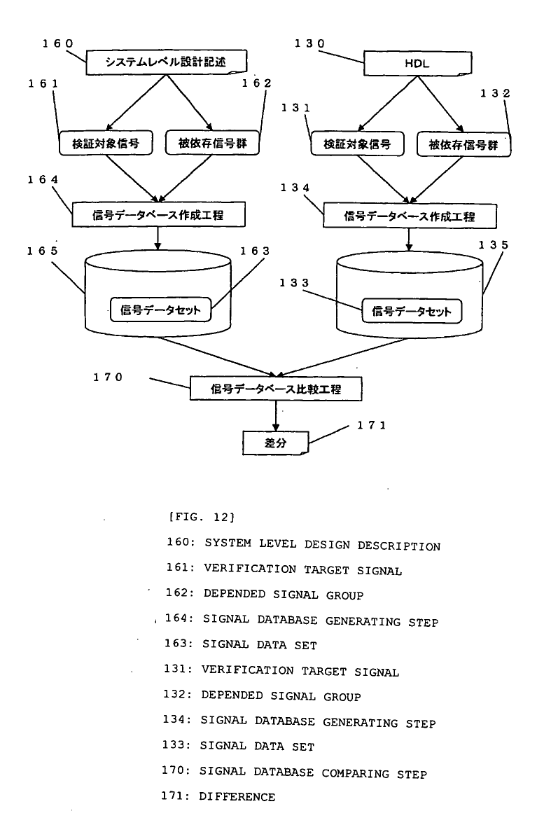

Next, a ninth embodiment of the present invention will be described. In the present embodiment, verification is performed by comparing a system level design description with a HDL description. FIG. 12 shows a configuration of respective steps and input/output information. As an example of descriptions having different description rules, the verification is performed by comparing the system level design description with the HDL description. As shown in FIG. 12, a verified signal related to a verifying signal is extracted from a system level design description 160, and a system level design description signal database 165 composed of a signal data set which associates a verification target signal having a defined operation with a depended signal group which influences the operation of the verification target signal is generated. A verified signal related to a verifying signal is extracted from the HDL description 130 on the LSI, and a verifying signal database 135 composed of a signal data set which associates a verification target signal having a defined operation with a depended signal group which influences the operation of the verification target signal is generated. The system level design signal database 165 and the HDL signal database 135 are compared with each other (170) to obtain a difference 171.

The matching/mismatching of each description is determined depending on whether the difference is in a predetermined range.

That is, a verification target signal 161 of which the operation is defined in the system level design description 160 and a depended signal group 162 which influences the operation of the verification target signal 161 are extracted from the system level design description 160, a signal data set 163 for associating the verification target signal 161 with the depended signal group 162 is generated (164), and the signal database 165 is generated by registering the signal data set 163 (signal database generating step 164).

A verification target signal 131 of which the operation is defined in the HDL description 130 generated from the specification document 110 of the LSI and a depended signal group 132 which influences the operation of the verification target signal 131 are extracted, a signal data set 133 for associating the verification target signal 131 with the depended signal group 132 is generated (134), and the signal database 135 is generated by registering the signal data set 133 (signal database generating step).

The signal data set 163 and the signal data set 133 are extracted from the signal database 165 and the signal database 135, respectively, and are compared with each other in a signal database comparing step 170 to obtain the difference 171. The matching/mismatching of each description is determined depending on whether the difference is in the predetermined range.

(Tenth Embodiment)

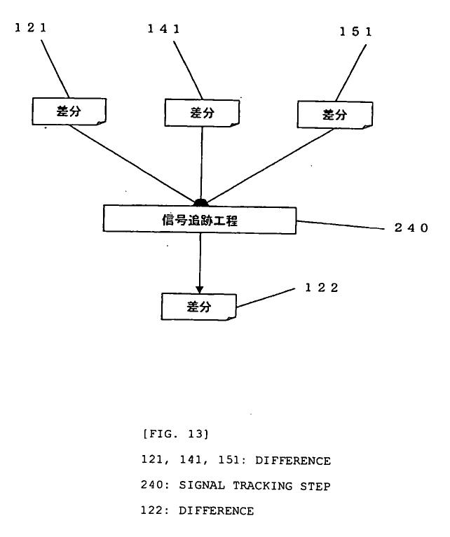

In the present embodiment, a state after extracting the difference will be described. FIG. 13 shows a method of performing a step 240 which tracks a signal using the results obtained by the LSI function verifying methods of the first, eighth and ninth embodiments, that is, the differences 121, 141 and 152. 121 denotes the difference obtained by comparing the specification signal database with the assertion description signal database, 141 denotes the difference obtained by comparing the specification signal database with the HDL signal database, 151 denotes the difference obtained by comparing the assertion description signal database with the HDL signal database, 240 denotes a signal tracking step which receives the difference 121, the difference 141 and the difference 151 and outputs a new difference, and 122 denotes a difference 122 generated in the signal tracking step 240. As described above, at least three different descriptions can be easily compared.

(Eleventh Embodiment)

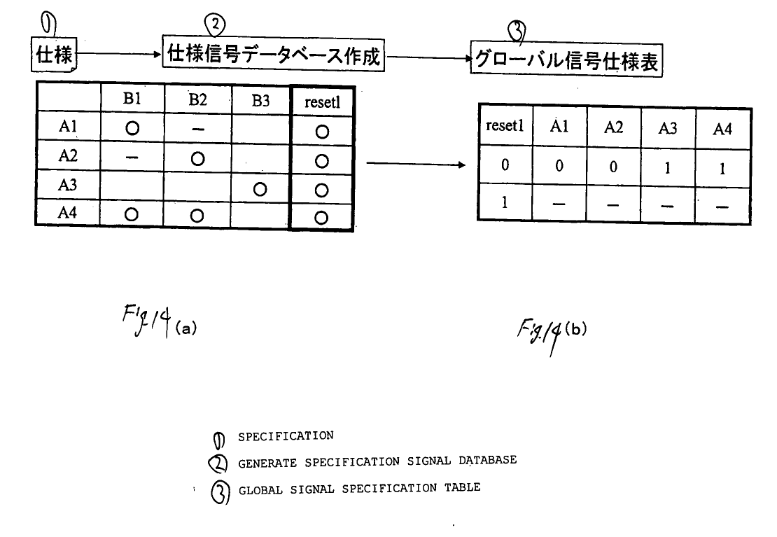

In the present embodiment, as shown in FIG. 14, with respect to the database generated in the signal database generating step, a signal for extracting depended signals which influence the operations of at least a specified number of verification target signals is extracted and treated as a global signal, thereby outputting a specification-format template for the signal. As shown in FIG. 14A, when the specification signal database is generated, a verified signal which directly influences at least three of verification target signals A1 to A4 is only a reset signal reset1 and a global signal specification database is generated as shown in FIG. 14B. When the reset signal reset1 is 0, the verification target signals A1, A2, A3 and A4 are 0, 0, 1 and 1, respectively, and, when the reset signal reset1 is 1, the verification target signals A1, A2, A3 and A4 are not changed with respect to the reset signal.

By finding the global signal and outputting a specification-format template for the signal, the format of the specification document can become uniform, treatment thereof can be simplified, and the quality level of the specification document can be improved.

(Twelfth Embodiment)

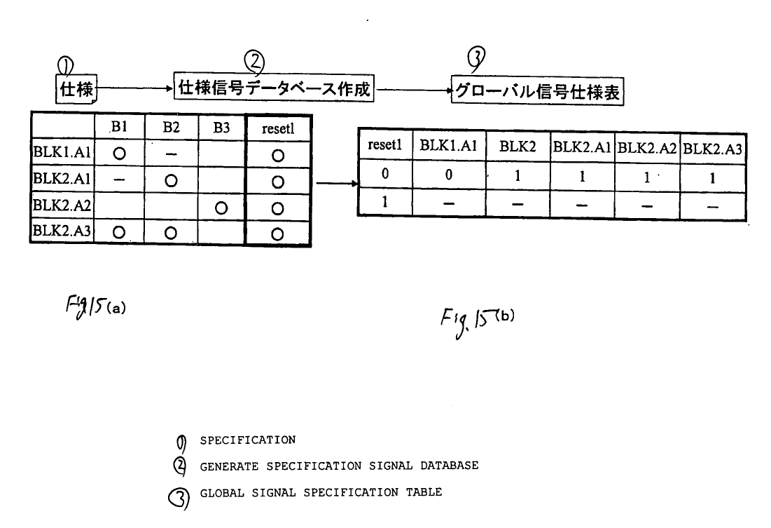

In the present embodiment, a global signal table, in which, with respect to the value of the global signal extracted in the eleventh embodiment or a value changing direction, verification target signals of which the operations are influenced by the global signal are collected to each functional block and, with respect to the functional block in which the operations of the verification target signals belonging to an identical functional block are identical, as shown in FIG. 15, (−) operation is described in the collective functional block to describe the operations of the verification target signals, is output.

As shown in FIG. 15A, when the specification signal database is generated, a verified signal which directly influences at least three of BLK1. A1 to A4 of a verification target signal block 1 is only a reset signal reset1 and a global signal specification database is generated as shown in FIG. 15B. When the reset signal reset1 is 0, BLK. A1, A2, A3 and A4 of the verification target signal block 1 are 0, 0, 1 and 1, respectively, and, when the reset signal reset1 is 1, BLK. A1, A2, A3 and A4 of the verification target signal block 1 are not changed with respect to the reset signal.

By finding the reset signal reset1 as the global signal and outputting a specification-format template for the signal, the format of the specification document can become uniform, treatment thereof can be simplified, and the quality level of the specification document can be improved.

By this configuration, in addition to the effect of the eleventh embodiment, when the verification target signals of the identical functional block perform the identical operation, an inputting step can be omitted.

(Thirteenth Embodiment)

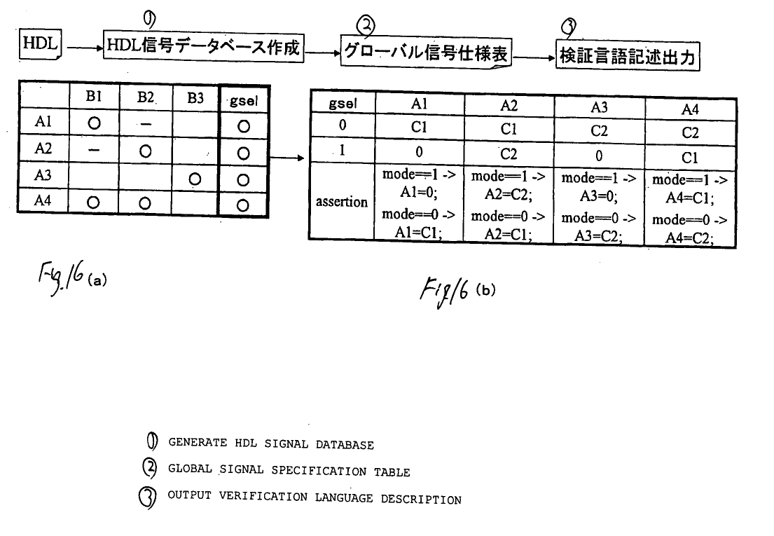

In the present embodiment, a global signal specification table, in which a mode attribute for changing a signal flow is given to a functional block in which the value of the verification target signal of which the operation is influenced by a global signal is uniquely determined by the value of the global signal, and, as shown in FIG. 16, the value of the verification target signal of which the operation is influenced by the global signal is set with respect to the value of the global signal, is output.

A description language for verifying a function can be output based on information on the global signal specification table and thus a process of generating a specification document can be omitted by outputting a specification-format template suitable for the global signal. In addition, an assertion description can be output based on information on the global signal specification table.

(Fourteenth Embodiment)

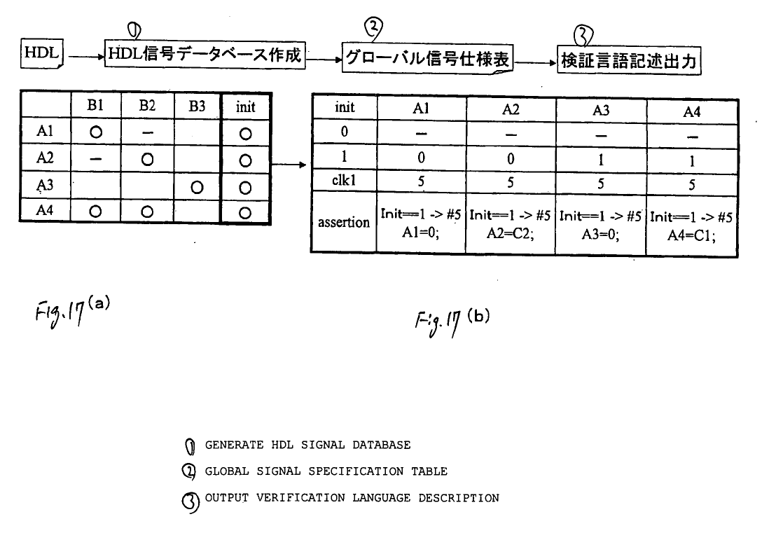

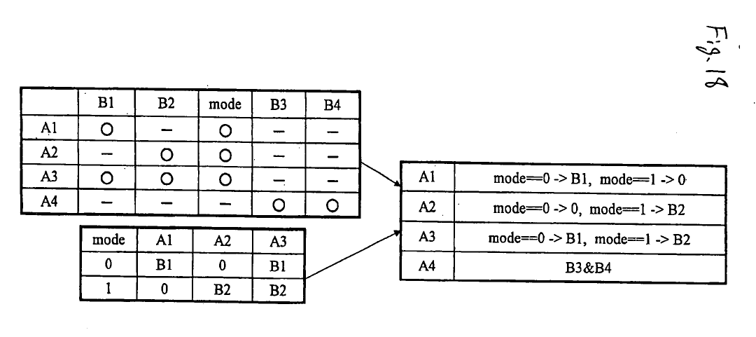

In the present embodiment, a global signal specification table, in which an initial sequence attribute (attribute of an input signal: an initializing signal) in which the value of a global signal and the value of the verification target signal of which the operation is influenced by the global signal within a predetermined period from a global signal changing time are uniquely determined is given to the global signal, and, as shown in FIGS. 17 and 18, with respect to the global signal and the predetermined period from the global signal changing time, the value of the verification target signal of which the operation is influenced by the global signal according to the attribute of the input signal can be set, is output. Here, init=1,#5A1=0 denotes that initialization A1=0 is performed by 5 clocks of the initialization signal. A description language for verifying a function can be output based on input information on a table output in a global signal specification table outputting step.

(Fifteenth Embodiment)

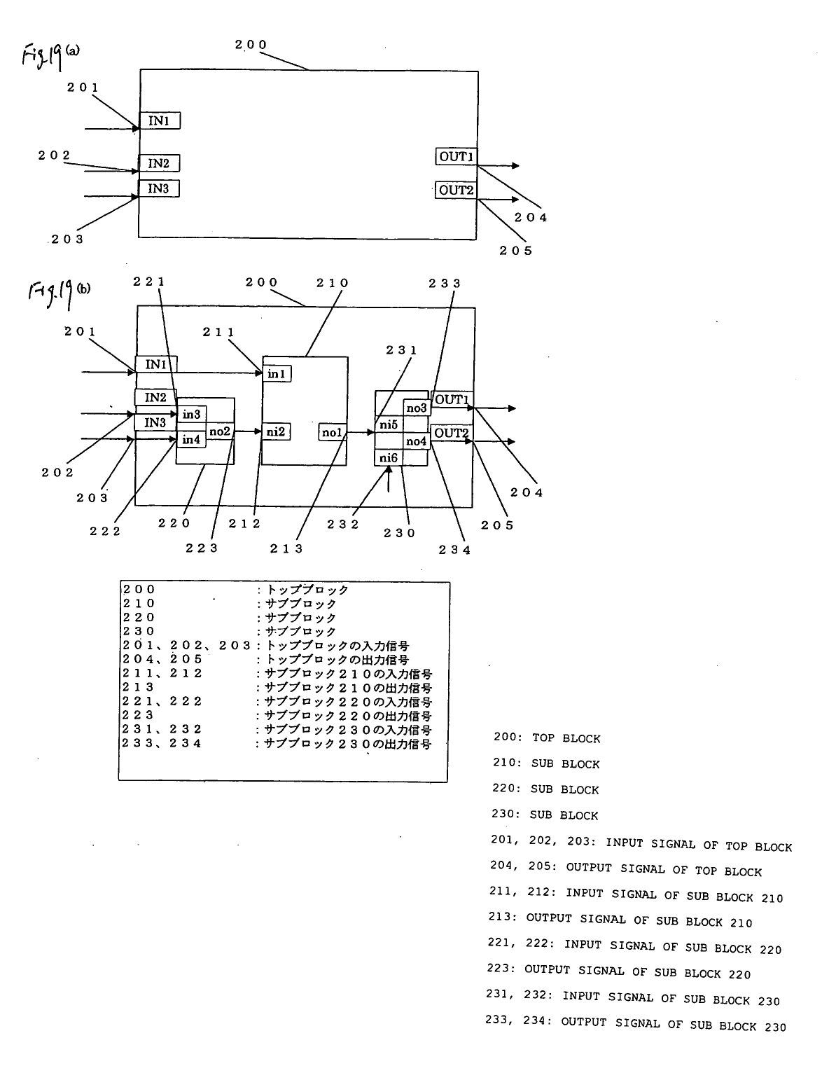

FIGS. 19A and 19B show a configuration of input/output signals of a specification document and input/output signals of a HDL when a verification target signal of the HDL does not exist in the specification document in the LSI function verifying method according to a fifteenth embodiment. In FIG. 19, 200 denotes a top block, 210, 220 and 230 denote a sub block 1, a sub block 2 and a sub block 3 of the top block, which are not described in the specification document, 201, 202 and 203 denote input signals of the top block, 204 and 205 denote output signals of the top block, 211 and 212 denote input signals of the sub block 210, 213 denotes an output signal of the sub block 210, 221 and 222 denote input signals of the sub block 220, 223 denotes an output signal of the sub block 220, 231 and 232 denote input signals of the sub block 230, and 233 and 234 denote output signals of the sub block 230. With respect to the output signal 213, an assertion description for verifying the operation thereof exists and the assertion description includes the input signal 211 and the operation of the output signal 213 defined by the operation of the input signal 212.

The configuration of respective steps and input/output information when verifying the function of the LSI using the signal data set in the fifteenth embodiment is similar to those shown in the tenth to thirteenth embodiments. With respect to the difference 121 obtained by comparing the specification signal database with the assertion description signal database, the difference 141 obtained by comparing the specification signal database with the HDL signal database, and the difference 151 obtained by comparing the assertion description signal database with the HDL signal database, a signal tracking step 240 which receives the difference 121, the difference 141 and the difference 151 and outputs a new difference 122 is performed.

A LSI function verifying method related to the description configured above will be described.

In FIG. 19, the output signal 213 of the sub block 210 is a verification target signal of the assertion description and depended signals of the output signal 213 are the input signal 211 and the input signal 212, both of which are not described in the specification document shown in FIG. 19A. In contrast, the difference 151 shown in FIG. 13 represents that both the depended signal group of the HDL and the depended signal group of the assertion description are the input signal 211 and the input signal 212 with respect to the output signal 213. On the HDL, the input signal 211 and the input signal 201 are connected to each other and the input signal 212 and the output signal 223 are connected to each other.

The signals which influence the operation of the output signal 223 are the input signal 221 and the input signal 222, the input signal 221 and the input signal 202 are connected with each other, and the input signal 222 and the input signal 203 are connected with each other. In this case, the operation of the output signal 213 is influenced by the input signal 201, the input signal 202 and the input signal 203.

Similarly, on the HDL, the output signal 213 are connected to the input signal 231, the input signal 231 is the signal which influences the operation of the output signal 233, and the output signal 23 is connected to the output signal 204. In this case, the operation of the output signal 204 is influenced by the output signal 213.

When the difference 141 is 0 and the input signal 201, the input signal 202 and the input signal 203 are the depended signals of the output signal 204 as the verification target signal in both the specification document and the HDL, it can be determined that the input signal 201, the input signal 202 and the input signal 203 which are the depended signal of the output signal 213 of an internal node of the HDL are matched with those of the specification document. The difference 151 represents that the input signal 211 and the input signal 212, which are the depended signals of the output signal 213 which is the verification target signal of the assertion description, are included in the depended signal group of the output signal 213 of the HDL, and, from the dependency relationship between the input signal 211 and the input signal 201 of the HDL and the dependency relationship among the input signal 212, the input signal 201 and the input signal 203, it can be determined that the relationship between the input signal 211 and the input signal 212, which are the depended signals of the output signal 213 of the assertion description, is matched with the relationship between the verification target signal 204 of the specification document and the input signal 201, the input signal 202 and the input signal 203, which are the depended signal.

(Sixteenth Embodiment)

In the present embodiment, a complex operation connection verification description language output step which outputs a description language for verifying a function based on input information of the connection logic operation input step is included, and assertion for block connection can be automatically output from the a specification between ports of the blocks and a mode signal specification.

For example, a port of a first functional block is registered as a first verification target signal and a port group of a second functional block which is connected with the first verification target signal is registered as a depended signal group of the first verification target signal in a specification signal database, and a first depended signal which influences the operations of at least two verification target signal groups is extracted as a global signal. A description language for verifying a function, which represents that the operations of a second verification target signal in a signal data set registered in a specification signal database and a second depended signal associated with the second verification target signal are always identical, is output, and a complex operation connection signal specification table which outputs a table for associating a depended signal group including a global signal of a third verification target signal of which the operation is influenced by the global signal extracted in the global signal extracting step with the third verification target signal is output. A logic operation due to a depended signal group of a fourth verification target signal which determines the value of the fourth verification target signal expressed in the complex operation connection signal specification table is input to the complex operation connection signal specification table output in a complex operation connection signal specification table output step. A description language for verifying a function is output based on the input information of the connection logic operation input step.

(Seventeenth Embodiment)

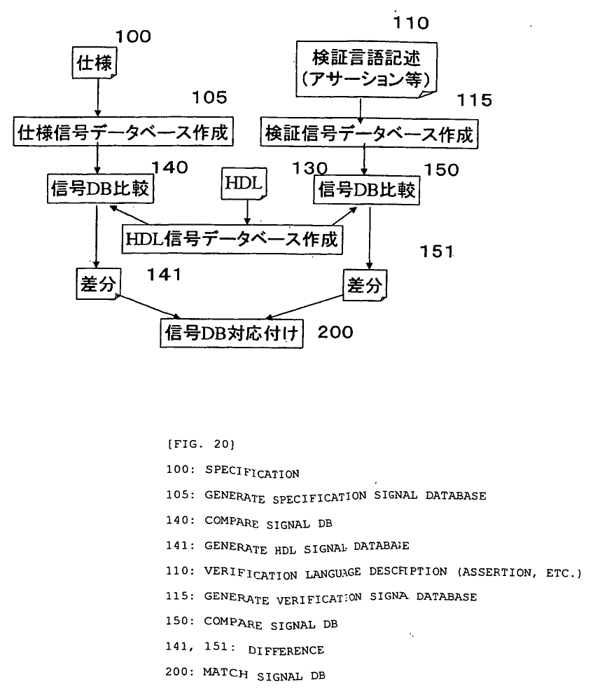

In the present embodiment, as shown in FIG. 20, a signal name of a description language for verifying a LSI function does not exist in a specification of the LSI, a difference 141 which is the result of a step 140 of comparing a specification signal database with a signal database of a description language for verifying the function is matched with a difference 151 which is the result of a step 150 of comparing an assertion description signal database with a HDL signal database in a matching step 200 and information associated with the specification with respect to the signal name is added.

When the signal name of the description language for verifying the function of the LSI does not exist in the specification of the LSI, from the result of the step of comparing the specification signal database with the signal database of the description language for verifying the function and the result of the step of comparing the specification signal database with the HDL signal database of the LSI, the information associated with the specification with respect to the signal name is added to a signal database generated in a step of generating the specification signal database and the signal database of the description language for verifying the function. Accordingly, missing information can be easily detected and supplemented.

(Eighteenth Embodiment)

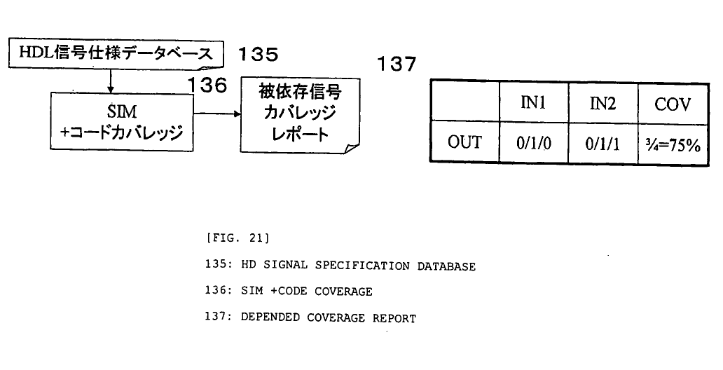

In the present embodiment, as shown in FIG. 21, with respect to a HDL of a LSI, a signal data set for associating a verification target signal of the HDL with a depended signal group which influences the operation of the verification target signal is registered to generate a signal database, simulation of the HDL is performed using the signal database as an input signal, a change in the value of a depended signal group is recorded in the signal data set in association with a depended signal. With respect to the combination of the value of the depended signal group in a signal coverage record 136, how many combinations of the change of the value of the depended signal group is recorded is output as a depended signal coverage report 137.

In the depended signal coverage report 137, information on whether each input signal is changed, whether each input signal has a value of 0/1, whether combinations of inputs are all satisfied, or whether the coverage of a step number level is satisfied is reported. Accordingly, if a signal dependency table of a specification can be compared, since the code coverage is linked, it is possible to detect the coverage of a test pattern which is viewed in the specification.

(Nineteenth Embodiment)

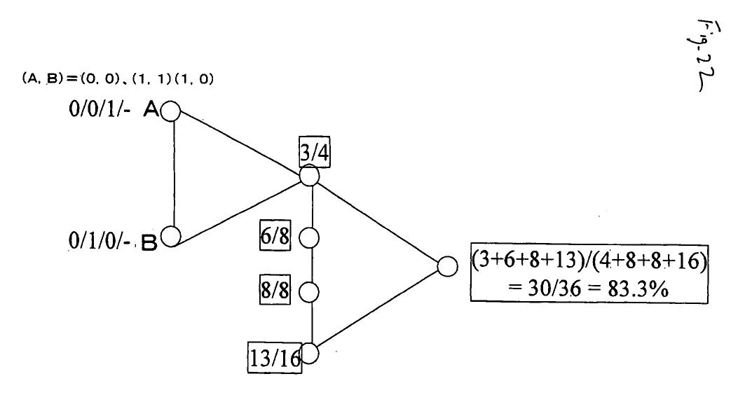

In the present embodiment, as shown in FIG. 22, the coverage results of previous stages are summed up to calculate the coverage.

For example, when two nodes A and B of a left stages are (A, B)=(0, 0), (1, 1) (1, 0) (that is, A=0/0/1/-, B=0/1/0/-), the code coverage of an uppermost node of a middle stage becomes 3/4. In addition, the code coverages of second, third and fourth nodes of the middle stage are 6/8, 8/8 and 13/16, respectively. In a node of a right stage, the four nodes of the middle stage are summed up and thus the number of the signal detection records for the combinations is 30/36, that is, the coverage is 84.4%. With respect to the combination of the change in the signal value of a first depended signal group of a first signal data set recorded in a signal coverage recording process, the recorded result is transferred to a second signal data set in which the first verification target signal of the first signal data set is a depended signal and thus the coverage can be efficiently calculated.

The LSI function verifying method according to the present invention can easily and efficiently verify a function, the present invention is applicable to verification of a super LSI or generation of a specification.

What is claimed is:

1. A database used for verifying a function of a LSI, wherein the database stores a signal data set which associates a verification target signal of the LSI having a defined operation with a depended signal group which influences the operation of the verification target signal is stored in a design specification or a description generated based on the design specification.

2. The database according to claim 1, wherein the database stores a first signal data set which associates a first verification target signal having a defined operation as the specification of the LSI with a first depended signal group which influences the operation of the first verification target signal, and a second signal data set which associates a second verification target signal which is a verification target in a description language for verifying the function of the LSI with a second depended signal group which influences the operation of the second verification target signal.

3. The database according to claim 1, wherein the database stores a first signal data set which associates a first verification target signal which is a verification target in a first description language for verifying the function of the LSI with a first depended signal group which influences the operation of the first verification target signal, and a second signal data set which associates a second verification target signal which is a verification target in a second description language for verifying the function of the LSI with a second depended signal group which influences the operation of the second verification target signal.

4. A method of verifying a function of a LSI, comprising:
a signal database generating step of generating a plurality of signal data sets for associating a verification target signal of the LSI having a defined operation with a depended signal group for influencing the operation of the verification target signal, with respect to design specifications or descriptions having a plurality of different description rules generated based on the design specifications; and
a signal database comparing step of comparing at least two of the signal data sets with each other and outputs a difference.

5. The method of verifying the function of the LSI according to claim 4, wherein the signal data sets are generated with respect to description levels having different abstract degrees, respectively.

6. The method of verifying the function of the LSI according to claim 4, comprising:
a first signal database generating step of registering a first signal data set for associating a first verification target signal of which the operation is defined as the specification of the LSI with a first depended signal group for influencing the operation of the first verification target signal;
a second signal database generating step of registering a second signal data set for associating a second verification target signal which is described in a description language for verifying the function of the LSI and is a verification target with a second depended signal group for influencing the operation of the second verification target signal; and
a signal database comparing step of comparing the first signal data set with the second signal data set and outputs a difference.

7. The method of verifying the function of the LSI according to claim 4, comprising:
a first signal database generating step of registering a first signal data set for associating a first verification target signal of which the operation is defined as the specification of the LSI with a first depended signal group for influencing the operation of the first verification target signal;
a second signal database generating step of registering a second signal data set for associating a second verification target signal which is described in a hardware description language (hardware description language; hereinafter, referred to as HDL) for expressing the function of the LSI and is a verification target with a second depended signal group for influencing the operation of the second verification target signal; and
a signal database comparing step of comparing the first signal data set with the second signal data set and outputs a difference.

8. The method of verifying the function of the LSI according to claim 4, comprising:
a first signal database generating step of registering a first signal data set for associating a first verification target signal of which the operation is defined as the specification of the LSI with a first depended signal group for influencing the operation of the first verification target signal;
a second signal database generating step of registering a second signal data set for associating a second verification target signal of a HDL for expressing the function of the LSI with a second depended signal group for influencing the operation of the second verification target signal; and
a signal database comparing step of comparing the first signal data set with the second signal data set and outputs a difference.

9. The method of verifying the function of the LSI according to claim 4, comprising:
a first signal database generating step of registering a first signal data set for associating a first verification target signal of a first HDL with a first depended signal group for influencing the operation of the first verification target signal;
a second signal database generating step of registering a second signal data set for associating a second verification target signal of a second HDL which is different from the first HDL in a time related to transmission/reception of data between signals with a second depended signal group for influencing the operation of the second verification target signal; and
a signal database comparing step of comparing the first signal data set with the second signal data set and outputs a difference.

10. The method of verifying the function of the LSI according to claim 4, comprising:
a step of adding information on delay time required until the first depended signal of the first signal data set influences the first verification target signal of the first signal data set to the first signal data set registered in the first signal database generating step in association with the first depended signal; and
a step of adding information a delay time required until the second depended signal of the second signal data set influences the second verification target signal of the second signal data set to the second signal data set registered in the second signal database generating step in association with the second depended signal.

11. The method of verifying the function of the LSI according to claim 10, wherein the information on the delay time is expressed by a clock signal and the number of clock cycles.

12. The method of verifying the function of the LSI according to claim 4, comprising:
a first or second signal database generating step of registering a signal data set for associating only a depended signal group which directly influences a verification target signal with the verification target signal.

13. The method of verifying the function of the LSI according to claim 11 or 12, comprising:
a clock signal table generating step of extracting a verification target signal and a depended signal of the verification target signal, which are synchronized with an identical clock signal, and generates a table list of signals which operate in synchronization with the clock signal, the depended signal directly influencing the verification target signal; and
a step of automatically setting the information on the delay time in which the clock signal and the number of the clock cycles are 1, from the clock signal table generated in the clock signal table generating step and the signal database generated in the signal database generating step.

14. The method of verifying the function of the LSI according to claim 4 or 8, comprising:
a global signal extracting step of extracting depended signals which influence the operations of at least a specified number of verification target signals, with respect to the database generated in the signal database generating step; and
a global signal specification table output step of outputting a table which can describe the operations of the verification target signals which are influenced by a global signal, with respect to the value of the global signal extracted in the global signal extracting step or a value changing direction.

15. The method of verifying the function of the LSI according to claim 14, comprising:
a global signal table output step of outputting a table which can describe the operation of the verification target signal by collecting the verification target signals of which the operations are influenced by the global signal to each functional block and describing each operation in each functional block with respect to the functional block in which the operations of the verification target signals belonging to the identical functional block are identical, with respect to the value of the global signal extracted in the global signal extracting step or a value changing direction.

16. The method of verifying the function of the LSI according to claim 14, comprising:
a step of giving a mode attribute to the global signal with respect to a functional block in which the value of the verification target signal, of which the operation is influenced by the global signal, is uniquely determined by the value of the global signal; and
a global signal specification output step of outputting a table which sets the value of the verification target signal, of which the operation is influenced by the global signal, with respect to the value of the global signal.

17. The method of verifying the function of the LSI according to claim 15, comprising:
a verification description language output step of outputting a description language for verifying the function based on input information on the table output in the global signal specification table output step.

18. The method of verifying the function of the LSI according to claim 16, comprising:
a step of giving an initial sequence attribute, in which the value of the global signal and the value of the verification target signal of which the operation is influenced by the global signal within a predetermined period from a global signal changing time are uniquely determined, to the global signal; and
a global signal specification output step of outputting a table which sets the value of the verification target signal, of which the operation is influenced by the global signal, with respect to the value of the global signal and the predetermined period from the global signal changing time.

19. The method of verifying the function of the LSI according to claim 18, comprising:
a verification description language output step of outputting a description language for verifying the function based on input information on the table output in the global signal specification table output step.

20. The method of verifying the function of the LSI according to claim 13 or 14, comprising:
a step of registering a port of a first functional block as a first verification target signal and registering a port group of a second functional block which is connected with the first verification target signal as a depended signal group of the first verification target signal, in a specification signal database;
a global signal extracting step of extracting a first depended signal which influences the operations of at least two verification target signal groups;
an identical operation connection verification description language output step of outputting a description language for verifying the function, which represents that the operations of a second verification target signal in a signal data set registered in the specification signal database and a second depended signal associated with the second verification target signal are always identical;
a complex operation connection signal specification table output step of outputting a table for associating a depended signal group including a global signal of a third verification target signal of which the operation is influenced by the global signal extracted in the global signal extracting step with the third verification target signal;
a connection logic operation input step of inputting a logic operation due to a depended signal group of a fourth verification target signal which determines the value of the fourth verification target signal expressed in the complex operation connection signal specification table to the complex operation connection signal specification table output in a complex operation connection signal specification table output step; and
a complex operation connection verification description language output step of outputting a description language for verifying the function based on the input information of the connection logic operation input step.

21. The method of verifying the function of the LSI according to claim 4, comprising:
a signal database generating step of registering a signal data set for associating a verification target signal of a HDL with a depended signal group which influences the operation of the verification target signal, with respect to the HDL of the LSI;
a simulating step of simulating the HDL by inputting signal database generated in the signal database generating step;
a signal coverage recording step of recording a change in the value of the depended signal group in the signal data set in association with the depended signal; and
a coverage output step of outputting how many combinations of the change of the value of the depended signal group is recorded, with respect to the combination of the value of the depended signal group in a signal coverage recording step.

22. The method of verifying the function of the LSI according to claim 21, comprising:
a depended signal value combination extracting step of adding the combination of the value of the depended signal group of the signal data set to the signal data set in association with the depended signal group; and
a depended signal value combination recording step of adding the number of the changes in each combination to the signal data set in association with the combination whenever the combination of the value of the depended signal group in the simulating step is changed.

23. The method of verifying the function of the LSI according to claim 21, comprising:
a coverage record transferring step of transferring a record result to a second signal data set in which a first verification target signal of a first signal data set is a depended signal, with respect to the combination of the signal value of a first depended signal group of the first signal data set recorded in the signal coverage recording step.

24. The method of verifying the function of the LSI according to any one of claims 4 to 8, comprising:
a step of, when a signal name of a description language for verifying the function of the LSI does not exist in a specification of the LSI, adding information for associating the signal name with the specification to a signal database generated in a third signal database generating step related to the description language for verifying the function and the specification, from the result of a first signal database comparing step related to the specification and the description language for verifying the function and the result of a second signal database comparing step related to the specification and the HDL of the LSI.
